(19) United States
(12) Patent Application Publication
(10) Pub. No.: US 2015/0332148 A1
(43) Pub. Date: Nov. 19, 2015

(54) FAILURE OCCURRENCE CAUSE EXTRACTION DEVICE, FAILURE OCCURRENCE CAUSE EXTRACTION METHOD, AND FAILURE OCCURRENCE CAUSE EXTRACTION PROGRAM

(71) Applicant: NEC Corporation, Minato-ku, Tokyo (JP)

(72) Inventors: Kunihiko SADAMASA, Tokyo (JP); Itaru HOSOMI, Tokyo (JP)

(21) Appl. No.: 14/417,596

(22) PCT Filed: Jul. 9, 2013
(86) PCT No.: PCT/JP2013/004240

§ 371 Date: Jan. 27, 2015

(30) Foreign Application Priority Data
Jul. 30, 2012 (JP) 2012-167991

(51) Int. Cl. G06N 5/04; G06F 17/28; G06F 17/30

(52) U.S. Cl. CPC G06N 5/04; G06F 17/30011; G06F 17/289; G06F 17/2863

(57) ABSTRACT

The present invention is capable of accurately and easily extracting a failure and a cause of occurrence of the failure on the basis of past cases. The present invention is provided with: a document storage unit (51) which stores a plurality of documents; a cause knowledge storage unit (52) which stores knowledge on cause containing expressions that represents a cause of acts and phenomena; a malfunction extraction unit (41) which extracts a malfunction expression from past cases represented by documents containing a question about a malfunction and an answer thereto; a possible cause extraction unit (42) which extracts, as an expression of a possible cause, an expression of a predetermined unit appearing in the past case from which the malfunction expression is extracted; a related document extraction unit (43) that extracts related documents regarding the expression of the possible cause and the malfunction expression, from the document storage unit; and a cause expression extraction unit (44) that selects a cause expression representing the cause of the malfunction from the expression of the possible cause, by using the related document and the knowledge on cause.

### TECHNICAL FIELD

The present invention relates to a malfunction cause extraction device that extracts a pair of a frequently appearing question about a malfunction of a product or service and an answer thereto, from a set of past cases including pairs of the questions and answers. In particular, the present invention relates to a malfunction cause extraction device that extracts a cause of the malfunction in order to facilitate the content of the question to be identified, when picking out a frequently appearing expression from the set of the past cases.

### BACKGROUND ART

Frequently asked questions (FAQ) is a collection of frequently appearing questions and answers thereto, made out in advance regarding products and services. When the FAQ is for example put on the homepage of a company, users can self-solve typical questions, thus being exempted from the trouble of making an inquiry to the contact center of the company. In addition, the answerers such as the operators of the contact center can refer to the FAQ when answering to the question, and therefore the cost for answering can also be reduced. Since the FAQ is thus quite useful, it is nowadays a common practice to attempt to automatically extract the items to be incorporated in the FAQ from the set of the past cases received at the contact center.

Patent Literature (PTL) 1 discloses a technique of composing a syntax tree through syntactic analysis of the questions in the past cases and extracting frequently appearing subtrees by a mining method to designate a past case tagged to an extracted subtree as a prospective item of the FAQ.

PTL 2 discloses a technique of clustering the past cases on the basis of similarity of documents among the cases, and designating a past case representative of each cluster as a prospective item of the FAQ.

Further, As techniques for extracting expressions that represent a cause of acts and phenomena, It is known as a method of storing and using, as knowledge in advance, clue expressions for extracting a cause mainly represented by conjunctive particles or pairs of words expressing acts and phenomena that tend to constitute a causal relationship (see, for example, PTL 3).

### CITATION LIST

### Patent Literature

PTL 1: Japanese Laid Open Patent Publication No. 2001-134575

PTL 2: Japanese Laid Open Patent Publication No. 2006-119991

PTL 3: Japanese Laid Open Patent Publication No. 2009-157791

### SUMMARY OF INVENTION

### Technical Problem

The technique according to PTL 1, however, can only extract the frequently appearing structures from a range in which the expressions are connected on the syntax tree, i.e., from a range in which the expressions are in a dependency relation with one another. In other words, the technique according to PTL 1 is unable to connect and extract expressions located at separate positions on the syntax tree, or combine expressions that appear in different sentences or paragraphs and extract such expressions as a unified frequently appearing substructure.

Thus, the PTL 1 has a drawback, in particular, in that the extraction of expression based on both the malfunction and the cause thereof is unable to be performed. It is desirable that the FAQ allows the user to uniquely identify, upon reading once, the remedy for the malfunction that the user is facing. To uniquely identify the remedy for the malfunction, first of all the description of the malfunction that has arisen is indispensable, and the cause of the malfunction has to be added, because different remedies have to be taken depending on the cause, though the malfunction is apparently the same. However, the malfunctions which have arisen and the causes thereof are often described in different sentences including questions and answers from different persons. Consequently, it is difficult to extract a substructure taking both the malfunction and the cause thereof into account.

The technique according to PTL 2 allows a frequently appearing substructure to be extracted by combining a plurality of expressions located at different positions. However, the techniques according to PTL 1 and PTL 2 are unable to assure that the expression representing the malfunction that has arisen is included in the frequently appearing expression. With the technique of PTL 2, in particular, the restriction on the extraction is less strict compared with PTL 1, and hence the clustering is more likely to be performed on the basis of information that is useless for uniquely identifying the content of the question, which leads to degraded accuracy of the FAQ thus made out.

To extract the expression representing the malfunction, for example clue expressions for extracting malfunctions and results of machine learning for extracting malfunctions may be stored in advance as knowledge, to make the most of such knowledge. Combining such a method with PTL 1 and PTL 2 allows extraction of substructures including the related malfunction. However, as stated above, the subject is unable to be uniquely identified with the expression representing the malfunction alone. For example, a malfunction that “battery of a mobile phone does not last” may arise from a plurality of causes such as “life of battery pack is ending” and “Bluetooth (registered trademark) is ON”, each of which requires a different remedy, and therefore the cause has to be acquired.

Here, the technique according to PTL 3 may be adopted to extract the cause of the malfunction, however, it takes enormous manpower to comprehensively collect in advance the pairs of words representing acts and phenomena that tend to constitute a causal relationship, and therefore it is practically unfeasible. In addition, the malfunctions are often described in the questions and the causes of the malfunction are often described in the answers, and therefore it is unusual that both the malfunction and the cause thereof appear in the same sentence or in two adjacent sentences. Consequently, it is still difficult to extract the cause of the malfunction, despite the clue expressions mainly represented by conjunctions and conjunctive particles being employed.

Accordingly, the present invention provides a malfunction cause extraction device, a malfunction cause extraction method and a malfunction cause extraction program that enable a malfunction and a cause thereof to be accurately extracted with ease from past cases.

### Solution to Problem

A malfunction cause extraction device according to the present invention includes:

a document storage unit that stores a plurality of documents;

a cause knowledge storage unit that stores knowledge on cause containing expressions that represent a cause of acts and phenomena;

a malfunction extraction unit that extracts a malfunction expression from past cases represented by documents containing a question about a malfunction and an answer thereto;

a possible cause extraction unit that extracts, as an expression of a possible cause, an expression of a predetermined unit appearing in the past case from which the malfunction expression is extracted;

a related document extraction unit that extracts related documents regarding the expression of the possible cause and the malfunction expression, from the document storage unit; and

a cause expression extraction unit that selects a cause expression representing the cause of the malfunction from the expression of the possible cause, by using the related document and the knowledge on cause.

A malfunction cause extraction method according to the present invention comprising:

storing a plurality of documents;

storing knowledge on cause containing expressions that represent a cause of acts and phenomena;

extracting a malfunction expression from past cases represented by documents containing a question about a malfunction and an answer thereto;

extracting, as an expression of a possible cause, an expression of a predetermined unit appearing in the past case from which the malfunction expression is extracted;

extracting related documents regarding the expression of the possible cause and the malfunction expression, from the document storage unit; and

selecting a cause expression representing the cause of the malfunction from the expression of the possible cause, by using the related document and the knowledge on cause.

A malfunction cause extraction program according to the present invention, for causing a computer to:

store a plurality of documents;

store knowledge on cause containing expressions that represent a cause of acts and phenomena;

extract a malfunction expression from past cases represented by documents containing a question about a malfunction and an answer thereto;

extract, as an expression of a possible cause, an expression of a predetermined unit appearing in the past case from which the malfunction expression is extracted;

extract related documents regarding the expression of the possible cause and the malfunction expression, from the document storage unit; and

select a cause expression representing the cause of the malfunction from the expression of the possible cause, by using the related document and the knowledge on cause.

### Advantageous Effects of Invention

The present invention enables a malfunction and a cause thereof to be accurately extracted with ease from past cases.

### BRIEF DESCRIPTION OF DRAWINGS

FIG. 1 is a block diagram illustrating a configuration of a malfunction cause extraction device according to the present invention.

FIG. 2 is a flowchart illustrating an operation of the malfunction cause extraction device according to the present invention.

FIG. 3 is an explanatory diagram illustrating a specific example of past cases.

FIG. 4 is an explanatory diagram illustrating specific examples obtained through morphological analysis of answers.

FIG. 5 is an explanatory diagram illustrating specific examples of expressions of possible cause.

FIG. 6 is an explanatory diagram illustrating a specific example of related documents.

FIG. 7 is an explanatory diagram illustrating specific examples of knowledge on cause.

FIG. 8 is a block diagram illustrating a configuration of a main part of the malfunction cause extraction device according to the present invention.

### DESCRIPTION OF EMBODIMENT

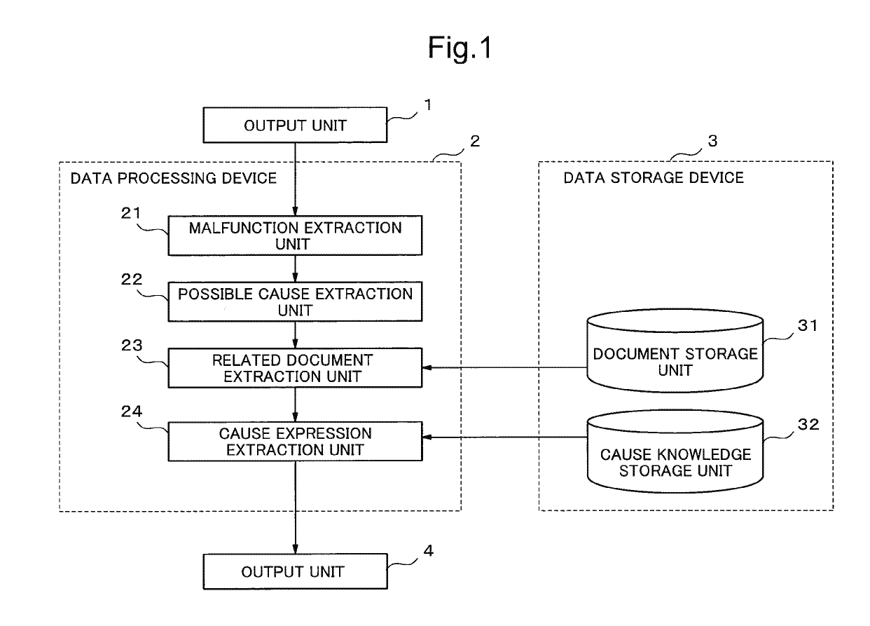

Hereafter, an exemplary embodiment of the present invention will be described in details with reference to the drawings. Although words and parts of speech of Japanese language will be used for the description, the present invention is not only applicable to Japanese language. In the following description, sentences and words expressed in Japanese may be expressed also in English, as the case may be. FIG. 1 is a block diagram illustrating a configuration of a malfunction cause extraction device according to the exemplary embodiment of the present invention. As illustrated in FIG. 1, the malfunction cause extraction device according to this exemplary embodiment includes an input unit 1, a data processing device 2 that operates under program control, a data storage device 3, and an output unit 4.

The input unit 1 is used to input past cases including question documents describing the content of a question about a malfunction and answer documents describing the answer to the question.

The data processing device 2 includes a malfunction extraction unit 21, a possible cause extraction unit 22, a related document extraction unit 23, and a cause expression extraction unit 24. The units in the data processing device 2 are realized, for example, by a central processing unit (CPU) that operates in accordance with a program.

The data storage device 3 includes a document storage unit 31 and a cause knowledge storage unit 32. The data storage device 3 is realized, for example, by a popular hard disk drive (HDD). The document storage unit 31 and the cause knowledge storage unit 32 are realized, for example, by a popular database.

The document storage unit 31 stores therein a plurality of documents, preferably a multitude of documents made by different persons.

The cause knowledge storage unit 32 stores therein knowledge on cause obtained by extracting expressions representing the cause of acts and phenomena.

The malfunction extraction unit 21 receives from the input unit 1 the past cases including the question documents describing the content of a question about a malfunction and the answer documents describing the answer to the question, and extracts malfunction expressions representing the malfunction, from the past cases.

The possible cause extraction unit 22 extracts one or a plurality of expressions that appear in the past cases from which the malfunction expressions have been extracted, in association with the malfunction expression, as an expression of the possible cause.

The related document extraction unit 23 extracts related documents that include both a similar expression to the associated malfunction expression and a similar expression to the expression of the possible cause, from the document storage unit 31. The related document extraction unit 23 may, for example, simply extract one or a plurality of documents that include both the malfunction expression and the expression of the possible cause, as the related document. Preferably, the related document extraction unit 23 may also extract, as the related document, one or a plurality of documents that include not only the identical expressions but also synonymous expressions that represent the same meaning with a different notation, with respect to each of the malfunction expression and the expression of the possible cause.

The cause expression extraction unit 24 applies the knowledge on cause in the cause knowledge storage unit 32 to the extracted related documents, and calculates the number of related documents in which each expression of the possible cause is decided to represent the cause of the expressed malfunction. The cause expression extraction unit 24 then selects the cause expression representing the cause of the malfunction from one or a plurality of expressions of the possible cause, depending on the number of the related documents.

The output unit 4 outputs the pair of the malfunction expression and the cause expression obtained as above.

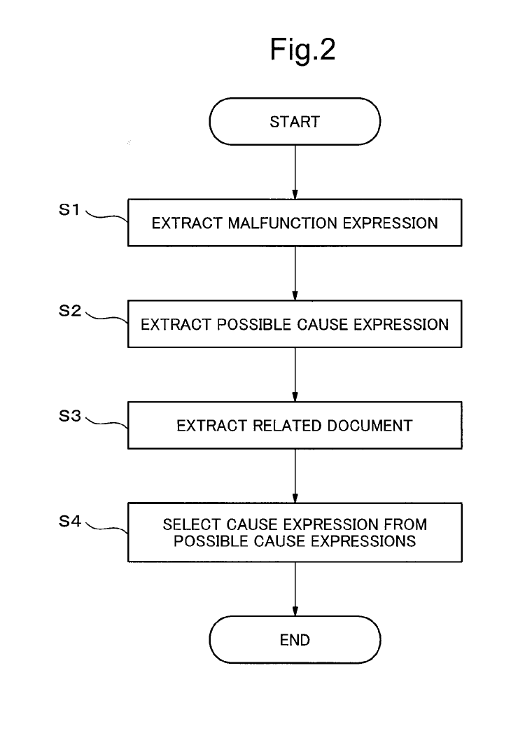

Hereunder, the operation of the malfunction cause extraction device according to this exemplary embodiment will be described in details. FIG. 2 is a flowchart illustrating the operation of the malfunction cause extraction device according to the exemplary embodiment of the present invention.

First, the malfunction extraction unit 21 receives from the input unit 1 the past cases including the question documents describing the content of the question about the malfunction and the answer documents describing the answer to the question, and extracts the malfunction expressions representing the malfunction, from the past cases (step S1).

Then the possible cause extraction unit 22 extracts one or a plurality of expressions that appear in the past cases from which the malfunction expressions have been extracted, in association with the malfunction expression, as an expression of the possible cause (step S2).

The related document extraction unit 23 extracts related documents that include both a similar expression to the associated malfunction expression and a similar expression to the expression of the possible cause, from the document storage unit 31 (step S3).

The cause expression extraction unit 24 applies the knowledge on cause in the cause knowledge storage unit 32 to the extracted related documents, and calculates the number of related documents in which each expression of the possible cause is decided to represent the cause of the expressed malfunction. The cause expression extraction unit 24 then selects the cause expression representing the cause of the malfunction from one or a plurality of expressions of the possible cause, depending on the number of the related documents, and outputs the pair of the malfunction expression and the cause expression obtained as above to the output unit 4 (step S4).

The advantageous effects of the malfunction cause extraction device according to this exemplary embodiment will now be described hereunder. In general, the cause of a malfunction is often described in the same past case. Accordingly, in the malfunction cause extraction device according to this exemplary embodiment the possible cause extraction unit 22 narrows down the possible cause of the malfunction by extracting the causes only from the past cases in which the malfunction is described. With such an arrangement, the malfunction cause extraction device according to this exemplary embodiment is capable of extracting the possible cause of the malfunction, without the need to prepare in advance the pairs of acts and phenomena that tend to constitute a causal relationship, as proposed by PTL 3.

The related document extraction unit 23 separately extracts and utilizes the documents to which the knowledge on cause is applicable, with respect to the possible cause that has been narrowed down, thereby allowing the cause expression supported by the knowledge on cause to be extracted. Therefore, the malfunction and the cause thereof, indispensable information for uniquely identifying the remedy for the malfunction described in the past cases, can be extracted from the past cases, when resultantly extracting the prospects of the FAQ from the set of the past cases, and consequently the content of the extracted question for the FAQ can be easily identified.

Hereunder, an example of the operation of the malfunction cause extraction device according to this exemplary embodiment will be described.

In the example described below, the past cases are assumed to be collected from a web site to which users can freely post an inquiry about a malfunction of a mobile phone, and other users who know the solution to the malfunction can post the answer to the inquired malfunction.

In addition, in this example the malfunction cause extraction device is assumed to extract the cause of the malfunction, with respect to each of the past cases accumulated in the website.

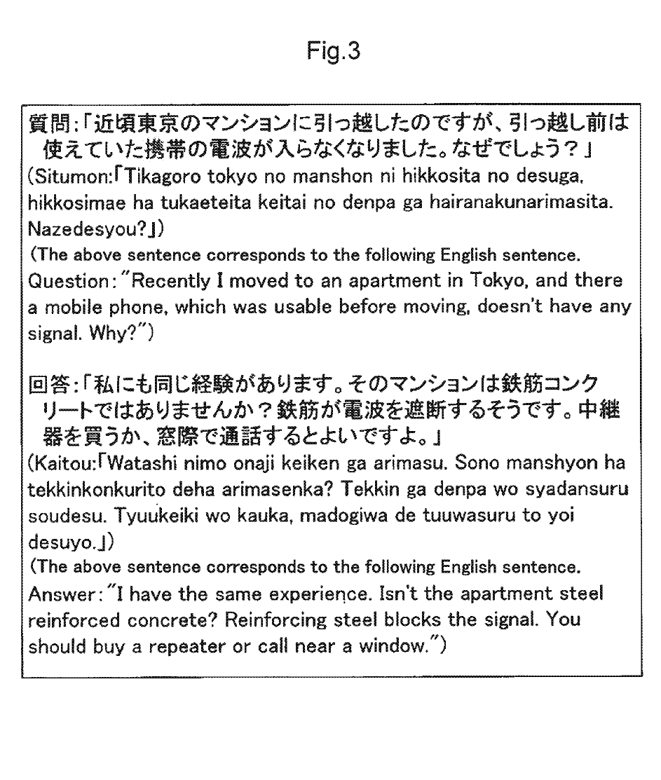

First, the malfunction extraction unit 21 receives from the input unit 1 the past cases including the question documents describing the content of the question about the malfunction and the answer documents describing the answer to the question. FIG. 3 illustrates a specific example of the past cases.

The malfunction extraction unit 21 extracts the malfunction expressions representing the malfunction from the past cases. A known method may be employed for the extraction by the malfunction extraction unit 21. For example, clue expressions often used for expressing malfunctions, such as “cannot do ˜”, “end up doing ˜”, and “doesn't do ˜” may be prepared in advance. In this case, the malfunction extraction unit 21 divides sentences to be extracted into units of words for structuring through a well-known analysis method such as morphological analysis or syntactic analysis, and then collates the analysis result with the clue expression prepared in advance, thereby extracting the matched parts as the malfunction expression.

Alternatively, the malfunction extraction unit 21 may employ a machine learning method. In this case, a multitude of documents in which the portions corresponding to the malfunction expression are manually tagged are prepared, and the malfunction extraction unit 21 performs the machine learning assuming that the tagged portions are the right answers, and automatically tags the portion corresponding to the malfunction to a new document, utilizing the model obtained as above.

The malfunction expression may be extracted in various units, such as in units of words, phrases, predicate-argument structures, sentences, or paragraphs. Any of those units may be adopted, however the smaller the unit of extraction is, for example words, the more abundant related documents can be extracted by the related document extraction unit 23 at the posterior stage, which allows the cause expression extraction unit 24 to decide more accurately whether the extracted expression is the cause expression. On the other hand, however, it becomes difficult to identify which malfunction the extraction result represents. In contrast, when the extraction is performed by a larger unit such as by sentences, although the content of the malfunction can be more easily identified on the basis of the extraction result, the number of related documents describing the malfunction, which constitute large units, is reduced and therefore the cause expression extraction unit 24 at the posterior stage is disabled from accurately deciding whether the extracted expression is the cause expression.

It is preferable that the malfunction extraction unit 21 adopts the predicate-argument structure or a combination of a declinable word and an indispensable case thereof, as the unit that facilitates both the identification of the content of the malfunction and the accurate decision whether the extracted expression is the cause expression. The indispensable case of the declinable word refers to the complement representing the factor indispensable for expressing the content of the declinable word. To extract the portion corresponding to the declinable word, for example, the declinable word phrase including a clue expression “doesn't have” may be first extracted, and then only “have” and the information representing negation “doesn't”, which constitute the declinable word essential for describing the malfunction, may be left. Deleting thus the information of minor importance thereby simplifying the malfunction expression allows the cause expression extraction unit 24 at the posterior stage to calculate scores on the basis of a larger amount of related documents, than when the sentence is not simplified.

In this example, the malfunction extraction unit 21 utilizes the combination of a declinable word and an indispensable case thereof. In the past case illustrated in FIG. 3, the malfunction extraction unit 21 extracts the expression “doesn't have” through the mentioned procedure using the clue expression representing the malfunction “doesn't do ˜”, and then extracts the malfunction expression “doesn't have any signal” by adding “signal” which is the indispensable case of “have”.

Then the possible cause extraction unit 22 extracts one or a plurality of expressions that appear in the past cases from which the malfunction expressions have been extracted, in association with the malfunction expression, as an expression of the possible cause. The expressions of the possible cause may be extracted by various units as the case of the malfunction expression, and each of the units provides the same advantages and disadvantages as those of the case of the malfunction expression. In this example, the expressions of the possible cause are extracted by combinations of a declinable word and an indispensable case thereof, as with the malfunction expression.

The possible cause extraction unit 22 may extract the expression of the possible cause from all of the past cases, however since the cause expressions are often described in the answers rather than in the questions in general, the possible cause extraction unit 22 may extract the expression of the possible cause only from the answers. Alternatively, the possible cause extraction unit 22 may preferentially handle the expression of the possible cause extracted from the answers, rather than the expression of the possible cause extracted from the questions. In the description given below, the possible cause extraction unit 22 extracts the expression of the possible cause only from the answers.

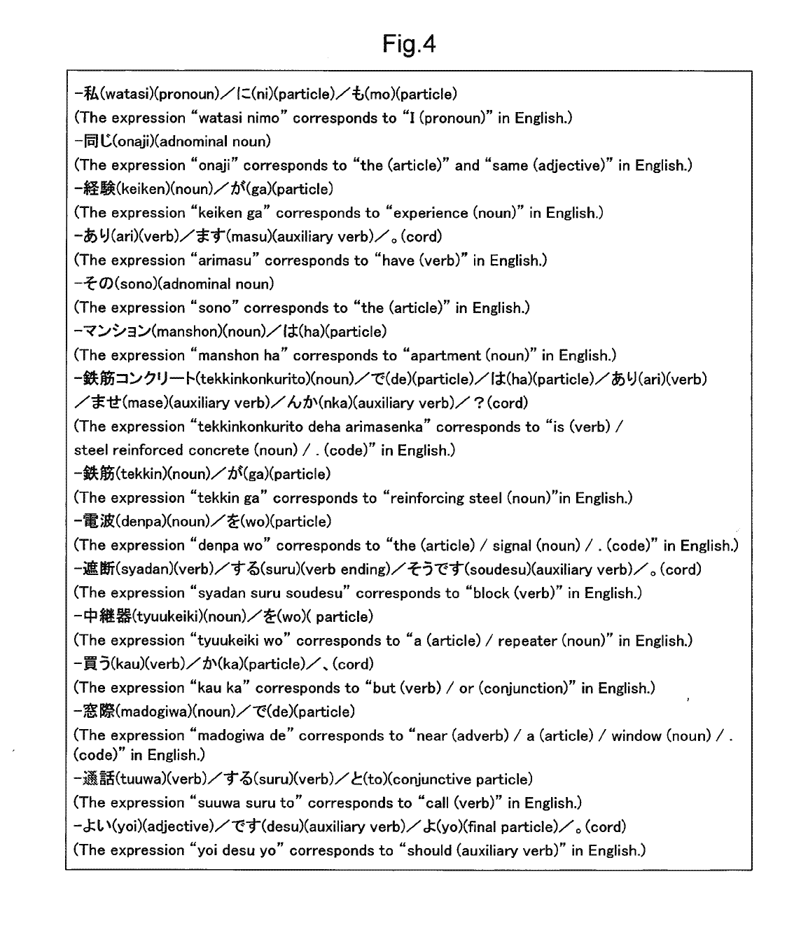

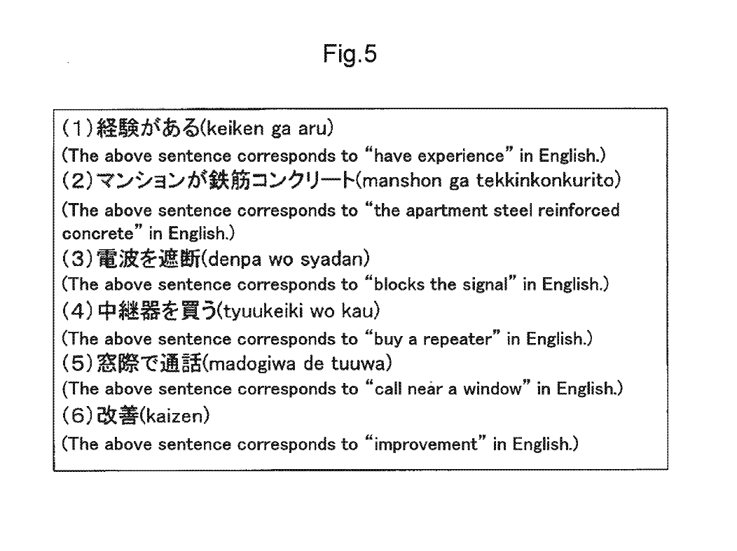

FIG. 4 illustrates specific examples obtained through morphological analysis of the answers in the past cases in FIG. 3. In FIG. 4, each line includes a phrase, and bold letters represent the words classified as declinable words. As is apparent from FIG. 4, the answer in the past case of FIG. 3 includes six types of declinable words, which are “aru”, “da”, “syadan”, “kau”, “tuuwa”, and “yoi” (in English, “have”, “is”, “block”, “buy”, “call”, and “should”, respectively). Accordingly, the possible cause extraction unit 22 picks up the information representing negation and the information representing the indispensable case on the basis of those declinable words, as when extracting the malfunction expression. FIG. 5 illustrates specific examples of the expression of the possible cause extracted from the answers in the past cases in FIG. 3. The possible cause extraction unit 22 resultantly extracts the six types of expressions of the possible cause presented in FIG. 5.

Then the related document extraction unit 23 extracts related documents that include both a similar expression to the associated malfunction expression and a similar expression to the expression of the possible cause, from the document storage unit 31. A multitude of documents are stored in advance in the document storage unit 31. It is preferable, for the cause expression extraction unit 24 to select the cause expression with high accuracy by pattern matching with the clue expressions, that a great deal of sentences describing the same content but in different expressions are stored. The multitude of documents may be prepared independently, or may be collected from the internet, and accumulated in the document storage unit 31. Alternatively, for example, the entirety of the documents available in the internet may be regarded as the document storage unit 31, and the related document extraction unit 23 may search the internet when necessary, to extract the required document.

In a simplest case, the related document extraction unit 23 extracts documents including both the malfunction expression and the expression of the possible cause, from the document storage unit 31. In this process, the related document extraction unit 23 may rearrange the searching method generally known in the field of language processing. For example, a conjugated form may be returned to the base form, or a modifier may be interposed in a phrase having the dependency relation, such as between “signal” and “doesn't have”.

However, a sufficient number of expressions may not be acquired through such searching based on the string of words. Accordingly, it is preferable that the related document extraction unit 23 expands the searching range so as to encompass the documents that include similar expressions to the malfunction expression and the expression of the possible cause, when extracting the related documents. There are various types of similar expressions, one of which is a synonymous expression that represents the same meaning with a different expression. For example, synonymous expressions of the Japanese words corresponding to “doesn't have” written in kanji may include “doesn't have” written in hiragana, and synonymous expressions of the Japanese words corresponding to “doesn't have any signal” may include Japanese words corresponding to “antenna-mark doesn't appear”. Thus, the related document extraction unit 23 may extract such documents that include, not only the malfunction expression and the expression of the possible cause as they are, but also the synonymous expression substituted for one or both thereof, as the related document. For example, the related document extraction unit 23 may pick up, as the malfunction expression, the Japanese words corresponding to “doesn't have any signal” written in hiragana, which is the synonymous expression substituted for “doesn't have any signal” written in kanji, when extracting the related documents.

Another example of the similar expression is superordinate and subordinate relationship in meaning, in a thesaurus typically exemplified by Wordnet. The thesaurus is expressed by directed graphs connecting between words including, for example, a relationship of “a kind of” representing such a relationship that “B is a kind of A”, and a relationship of “a part of” representing such a relationship that “C is a part of A”. For example, “apartment” and “building” are in the relationship of “a kind of” since “apartment” is a kind of “building”, and “building” is a superordinate word of “apartment”. In this case, an expression including the superordinate word “building is (made of) a steel reinforced concrete” semantically includes the original expression “apartment is (made of) a steel reinforced concrete”, which is called “implication” in the field of language processing. Thus, the related document extraction unit 23 may also extract such documents that include, instead of the malfunction expression and the expression of the possible cause as they are, the expression that implies of one or both thereof, as the related document.

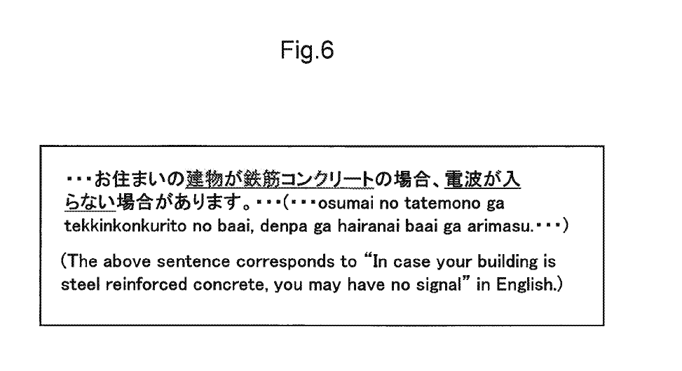

FIG. 6 illustrates a specific example of the related document. This example represents one of 100 documents, which include related document presented in FIG. 6, extracted by the related document extraction unit 23, as a result of the extraction of the related documents based on also the similar expression, with respect to the pair of the malfunction expression “doesn't have any signal” and the expression of the possible cause “apartment is (made of) a steel reinforced concrete”. The related document extraction unit 23 also extracts the related documents in the same way with respect to other expressions of the possible cause. It is herein assumed that existing dictionaries and known techniques are employed as the synonymous expression and the thesaurus used for substituting the expressions.

Then the cause expression extraction unit 24 applies the knowledge on cause in the cause knowledge storage unit 32 to the extracted related document. The cause knowledge storage unit 32 stores therein the knowledge on cause to be utilized for extracting the expressions representing the cause of acts and phenomena, from the documents. The cause knowledge storage unit 32 may store, for example, a clue expression dictionary containing patterns that may indicate a cause.

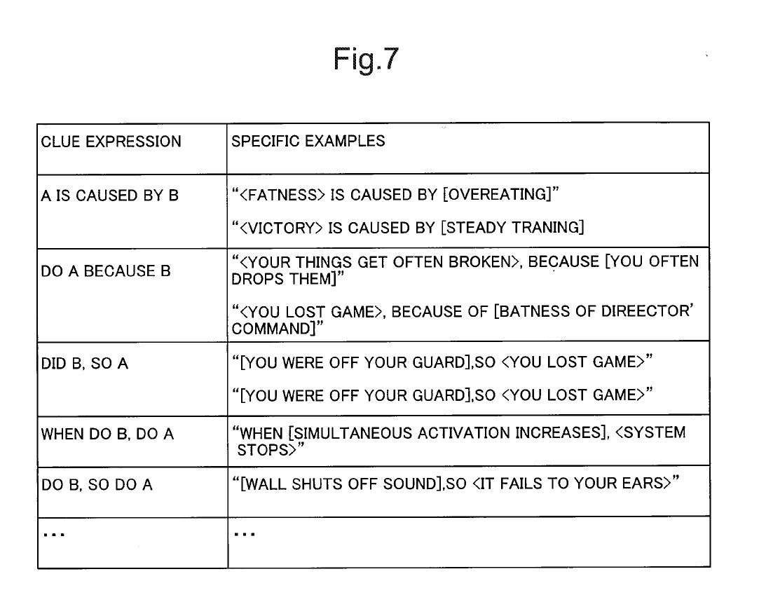

FIG. 7 is a table illustrating specific examples of the knowledge on cause. In FIG. 7, < > represents a result, and [ ] represents a cause that leads to the result. The term “pattern that may indicate that an expression A is a cause of an expression B” refers to an expression by which it can be identified, with the pattern alone, that A is the cause of B, for example “A is caused by B”, “Do A because B”, “Did B, so did A”, “When do B, do A”, and “Do B, so do A”. As another example, the cause knowledge storage unit 32 may store statistic data learned on the basis of a great deal of expressions representing the relationship between the remedy and the cause of the malfunction.

For example, the cause expression extraction unit 24 can identify, upon applying the clue expression “When do B, do A” in FIG. 7 to the extracted sentence exhibited in FIG. 6, that the expression of the possible cause “apartment is (made of) a steel reinforced concrete” corresponds to the cause of the malfunction expressed as “doesn't have any signal” in this document. The cause expression extraction unit 24 applies the knowledge on cause to the remaining ones of the 100 extracted documents, and counts the number of documents in which the expression of the possible cause has been identified as the cause of the expressed malfunction. Such counting is also performed with respect to the five types of the expressions of the possible cause.

The cause expression extraction unit 24 calculates the score that serves as the reference to decide whether the expression of the possible cause corresponding to the related document is the expression representing the cause of the associated malfunction. The cause expression extraction unit 24 then selects a cause expression representing the cause of the malfunction according to the score, from one or a plurality of expressions of the possible cause. As a simple procedure, the cause expression extraction unit 24 may use the number of documents counted in the preceding step as the score, and extract the expression of the possible cause having a high score as the cause expression. For example, when the number of documents in which the expression “apartment is (made of) a steel reinforced concrete” appears as the cause is larger than the number of documents including other expressions of the possible cause, the cause expression extraction unit 24 selects “apartment is (made of) a steel reinforced concrete” as the cause expression.

Here, the expression of the possible cause extracted as the cause of a large number of malfunction expressions is highly likely to be a customary epithet applicable to various types of malfunction, i.e., a noise. Accordingly, the cause expression extraction unit 24 may use a relevant factor in combination with the number of documents, to thereby correct the extraction result. In this case, a known measure such as amount of mutual information or Dice's coefficient may be employed, which indicate the interdependence between the malfunction expression and the cause expression (to which extent it can be presumed, by finding a cause expression in a past case, whether a malfunction expression appears in the same past case, or vice versa). In the description given below, the amount of mutual information is employed.

The amount of mutual information I(fᵢ, oⱼ) between fi and oⱼ can be expressed as the equation (1) cited below, where fi represents the i-th malfunction expression and of represents the j-th cause expression. In the equation (1), N is the total number of documents in the document storage unit, N(fᵢ) is the number of past cases in which fᵢ is selected as the malfunction expression, N(oⱼ) is the number of past cases in which oⱼ is selected as the cause expression, and N(fᵢ, oⱼ) is the number of past cases in which fᵢ and oⱼ picked up by the searching constitute the relationship of the malfunction expression and the cause expression.

$$\begin{matrix}[ Math . 1 ] & \\ I ( {f}_{i} , {o}_{j} ) = {log}_{2} \frac{N ( {f}_{i} , {o}_{j} ) \times N}{N ( {f}_{i} ) \times N ( {o}_{j} )} & ( 1 )\end{matrix}$$

The cause expression extraction unit 24 excludes the cause expressions that make the amount of mutual information I(fᵢ, oⱼ) lower than a certain level, as being a noise. Here, a plurality of cause expressions may be selected, instead of just one.

Hereunder, the advantageous effects of the malfunction cause extraction device according to this example will be described. In this example, the possible cause extraction unit 22 narrows down the possible cause of the malfunction by extracting the causes only from the past cases in which the malfunction is described. Therefore, the possible cause of the malfunction can be easily extracted, without the need to prepare in advance the pairs of acts and phenomena that tend to constitute a causal relationship, as proposed by PTL 3.

In the malfunction cause extraction device according to this example, the related document extraction unit 23 extracts the documents to which the knowledge on cause is applicable and the cause expression extraction unit 24 utilizes the documents, with respect to the possible cause that has been narrowed down, thereby allowing the cause expression supported by the knowledge on cause to be extracted. Therefore, the malfunction cause extraction device according to this example enables the malfunction and the cause thereof, indispensable information for uniquely identifying the remedy for the malfunction described in the past cases, to be accurately extracted from the past cases, when resultantly extracting the prospects of the FAQ from the set of the past cases.

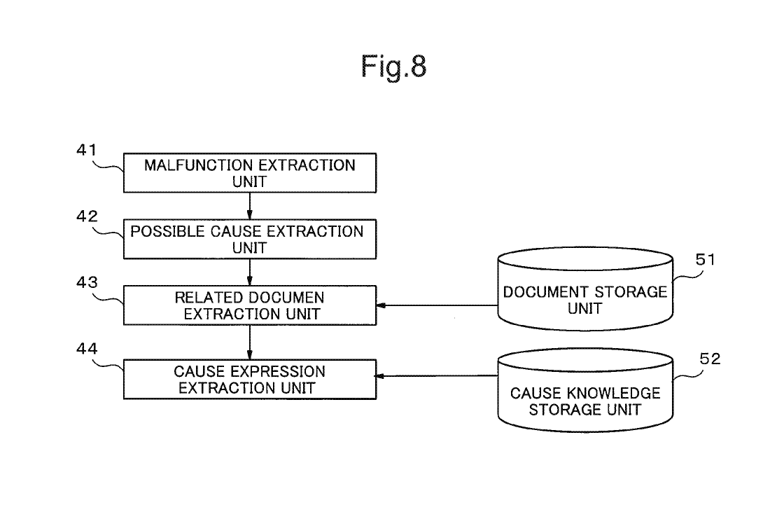

FIG. 8 is a block diagram illustrating a configuration of a main part of the malfunction cause extraction device according to the present invention. As illustrated in FIG. 8, the malfunction cause extraction device according to the present invention includes a document storage unit 51 that stores therein a plurality of documents, a cause knowledge storage unit 52 that stores therein knowledge on cause including expressions that represent causes of acts and phenomena, a malfunction extraction unit 41 that extracts a malfunction expression from past cases which are documents containing a question about a malfunction and an answer thereto, a possible cause extraction unit 42 that extracts, as expression of a possible cause, an expression of a predetermined unit appearing in the past case from which the malfunction expression is extracted, a related document extraction unit 43 that extracts related documents regarding the expression of the possible cause and the malfunction expression, from the document storage unit 51, and a cause expression extraction unit 44 that selects a cause expression representing the cause of the malfunction from the expression of the possible cause, by using the related document and the knowledge on cause.

The foregoing exemplary embodiment also encompasses the malfunction cause extraction device defined as (1) to (4) here below.

(1) A malfunction cause extraction device including a document storage unit (for example, document storage unit 31) that stores therein a plurality of documents, a cause knowledge storage unit (for example, cause knowledge storage unit 32) that stores therein knowledge on cause containing expressions that represent causes of acts and phenomena, a malfunction extraction unit (for example, malfunction extraction unit 21) that extracts a malfunction expression from past cases represented by documents containing a question about a malfunction and an answer thereto, a possible cause extraction unit (for example, possible cause extraction unit 22) that extracts, as an expression of a possible cause, an expression of a predetermined unit appearing in the past case from which the malfunction expression is extracted, a related document extraction unit (for example, related document extraction unit 23) that extracts related documents regarding the expression of the possible cause and the malfunction expression, from the document storage unit, and a cause expression extraction unit (for example, cause expression extraction unit 24) that selects a cause expression representing the cause of the malfunction from the expression of the possible cause, by using the related document and the knowledge on cause.

(2) In the malfunction cause extraction device, the related document extraction unit may be configured to extract the related document that include both a similar expression to the expression of the possible cause and a similar expression to the malfunction expression, from the document storage unit. The malfunction cause extraction device thus configured allows extraction of a sufficient number of related documents regarding the malfunction expression and the expression of the possible cause.

(3) In the malfunction cause extraction device, the malfunction extraction unit may be configured to extract the malfunction expression in units of predicate-argument structures or combinations of a declinable word and an indispensable case thereof, and the possible cause extraction unit may be configured to extract the expression of the possible cause in units of the predicate-argument structures or the combinations of the declinable word and the indispensable case thereof. The malfunction cause extraction device thus configured provides both clarity of the detail of the malfunction and accuracy of decision whether the extracted expression is the cause expression.

(4) In the malfunction cause extraction device, the cause expression extraction unit may be configured to apply the knowledge on cause to the extracted related documents, calculate the number of related documents in which the expression of the possible cause is decided to represent the cause of the expressed malfunction, and select the cause expression from the expressions of the possible cause, according to the number of the related documents. The malfunction cause extraction device thus configured allows the cause expression corresponding to the malfunction expression to be easily extracted.

This application claims priority based on Japanese Patent Application No. 2012-167991 filed on Jul. 30, 2012, the content of which is incorporated hereinto by reference in its entirety.

Although the present invention has been described with reference to the exemplary embodiment and the examples, the present invention is in no way limited to the r and the examples. The configuration and details of the present invention may be modified in various manners that are obvious to those skilled in the art, within the scope of the present invention.

### INDUSTRIAL APPLICABILITY

The present invention is applicable to FAQ, for example put on the homepage of a company and composed of questions about malfunctions and the answers thereto regarding the products and services of the company.

### REFERENCE SIGNS LIST

1 input unit
2 data processing device
3 data storage device
4 output unit
21 malfunction extraction unit
22 possible cause extraction unit
23 related document extraction unit
24 cause expression extraction unit
31 document storage unit
32 cause knowledge storage unit
41 malfunction extraction unit
42 possible cause extraction unit
43 related document extraction unit
44 cause expression extraction unit
51 document storage unit
52 cause knowledge storage unit

What is claimed is:

1. A malfunction cause extraction device comprising:
a document storage unit that stores a plurality of documents;
a cause knowledge storage unit that stores knowledge on cause containing expressions that represent a cause of acts and phenomena;
a malfunction extraction unit that extracts a malfunction expression from past cases represented by documents containing a question about a malfunction and an answer thereto;
a possible cause extraction unit that extracts, as an expression of a possible cause, an expression of a predetermined unit appearing in the past case from which the malfunction expression is extracted;
a related document extraction unit that extracts related documents regarding the expression of the possible cause and the malfunction expression, from the document storage unit; and
a cause expression extraction unit that selects a cause expression representing the cause of the malfunction from the expression of the possible cause, by using the related document and the knowledge on cause.

2. The malfunction cause extraction device according to claim 1,
wherein the related document extraction unit is configured to extract the related document that include both a similar expression to the expression of the possible cause and a similar expression to the malfunction expression, from the document storage unit.

3. The malfunction cause extraction device according to claim 1,
wherein the malfunction extraction unit is configured to extract the malfunction expression in units of predicate-argument structures or combinations of a declinable word and an indispensable case thereof, and
the possible cause extraction unit is configured to extract the expression of the possible cause in units of the predicate-argument structures or the combinations of the declinable word and the indispensable case thereof.

4. The malfunction cause extraction device according to claim 1,
wherein the cause expression extraction unit is configured to apply the knowledge on cause to the extracted related documents, calculate the number of related documents in which the expression of the possible cause is decided to represent the cause of the expressed malfunction, and select the cause expression from the expressions of the possible cause, according to the number of the related documents.

5. A malfunction cause extraction method comprising:
storing a plurality of documents;
storing knowledge on cause containing expressions that represent a cause of acts and phenomena;
extracting a malfunction expression from past cases represented by documents containing a question about a malfunction and an answer thereto;
extracting, as an expression of a possible cause, an expression of a predetermined unit appearing in the past case from which the malfunction expression is extracted;
extracting related documents regarding the expression of the possible cause and the malfunction expression, from the document storage unit; and
selecting a cause expression representing the cause of the malfunction from the expression of the possible cause, by using the related document and the knowledge on cause.

6. A non-transitory computer readable medium storing a malfunction cause extraction program for causing a computer to:
store a plurality of documents;
store knowledge on cause containing expressions that represent a cause of acts and phenomena;
extract a malfunction expression from past cases represented by documents containing a question about a malfunction and an answer thereto;
extract, as an expression of a possible cause, an expression of a predetermined unit appearing in the past case from which the malfunction expression is extracted;
extract related documents regarding the expression of the possible cause and the malfunction expression, from the document storage unit; and
select a cause expression representing the cause of the malfunction from the expression of the possible cause, by using the related document and the knowledge on cause.

7. A data processing device for extracting a malfunction cause comprising:
a malfunction extraction unit that extracts a malfunction expression from past cases represented by documents containing a question about a malfunction and an answer thereto;
a possible cause extraction unit that extracts, as an expression of a possible cause, an expression of a predetermined unit appearing in the past case from which the malfunction expression is extracted;
a related document extraction unit that extracts related documents regarding the expression of the possible cause and the malfunction expression, from a plurality of documents; and
a cause expression extraction unit that selects a cause expression representing the cause of the malfunction from the expression of the possible cause, by using the related document and knowledge on cause containing expressions that represent a cause of acts and phenomena.
